(19) United States
(12) Patent Application Publication
(10) Pub. No.: US 2005/0061294 A1
(43) Pub. Date: Mar. 24, 2005

(54) Direct fuel-injected internal combustion engine having improved spark ignition system

(76) Inventor: Matthew L Bridge, Troy, OH (US)

Correspondence Address: BOMBARDIER RECREATIONAL PRODUCTS INC;INTELLECTUAL PROPERTY DEPT, PO BOX 230, NORTON, VT, 05907-0230, US

(21) Appl. No.: 10/497,651

(22) PCT Filed: Dec. 13, 2002
(86) PCT No.: PCT/US02/39907

Related U.S. Application Data
(60) Provisional application No. 60/339,987, filed on Oct. 30, 2001.

(51) Int. Cl. F02B 5/00; F02P 1/00

(52) U.S. Cl. 123/305; 123/634; 123/73 C

(57) ABSTRACT

A direct fuel injection outboard marine engine having an improved spark ignition system. This spark ignition system includes a magnetic core-coil assembly for generating a high-voltage signal within a short period of time and an electronic engine management module for energizing a primary coil of the magnetic core-coil assembly with a low-voltage signal at the appropriate time. The magnetic core is made of ferromagnetic amorphous metal alloy which exhibits low core loss and a permeability in the range of 100 to 500. The high-voltage signal is output by a secondary coil wound around a major portion of the core, with the primary coil being wound around a minor portion of the core. The secondary coil outputs a high-voltage signal to a spark plug in response to excitation of the primary coil with a low-voltage signal generated by the electronic engine management module.

### FIELD OF THE INVENTION

This invention generally relates to direct fuel-injected internal combustion engines, such as two-stroke or four-stroke engines. In particular, the invention relates to marine propulsion systems which include such engines.

### BACKGROUND OF THE INVENTION

The most common internal combustion engines are classified as either two-stroke cycle or four-stroke cycle. The majority of outboard marine engines use two-stroke technology, but there are also outboard marine engines that use four-stroke technology. The engine technologies used in outboard marine engines are selected based on the power, performance and efficiency needs of the specific engine family.

Direct fuel injection is a process of injecting fuel charge directly into the combustion chamber. Modern direct fuel injection technology uses an electronic engine management system to coordinate delivery of precise fuel quantities into the combustion chamber.

One known injection method blasts highly pressurized fuel into the combustion chamber at a cyclic rate of up to 100 times per second at pressures up to 450 psi. Pulsing the fuel in this way enhances the fuel burn to fuel efficiency. Because the pulsing of the fuel is timed to occur after the piston has closed off the exhaust port, the amount of unburned fuel which escapes can be reduced. Therefore, hydrocarbon emissions are reduced and fuel economy is enhanced. In addition, superior fuel economy and performance are attained by incorporating a sensor which constantly monitors the exhaust pressure. This sensor provides feedback to the electronic engine management system, which then optimizes fuel delivery for the best performance and economy under any operating condition. The result is a high-performance engine having the high power-to-weight ratio expected of a two-stroke powerplant plus the fuel economy and efficiency expected of a four-stroke engine.

In two- and four-stroke internal combustion engines, a high voltage is needed to create an arc across the gap of the spark plug for igniting the mixture of fuel and air in the combustion chamber. The timing of the spark ignition is critical for best fuel economy and low exhaust emission of environmentally hazardous gases. Tardy spark ignition leads to loss of engine power and loss of efficiency, while early spark ignition leads to detonation, often called “ping” or “knock”, which can, in turn, lead to detrimental pre-ignition and subsequent engine damage.

Correct spark timing is dependent on engine speed and load. Each cylinder of an engine often requires different timing for optimum performance. Different spark timing for each cylinder can be obtained by providing a spark ignition transformer for each spark plug. To improve engine efficiency and alleviate some of the problems associated with inappropriate spark ignition timing, modern outboard marine engines are equipped with microprocessor-controlled systems which include sensors for providing feedback concerning relevant engine performance parameters.

A disproportionately greater amount of exhaust emission of hazardous gases is created during the initial operation of a cold engine and during idle and off-idle operation. Rapid pulsing of the spark plug for each ignition event during these two regimes of engine operation reduces hazardous exhaust emissions. Accordingly, it is desirable for an outboard marine engine to have a spark ignition transformer which can be charged and discharged very rapidly. In addition, extended part throttle operation and cold starts can lead to the deposition of electrically conductive soot on the spark plug insulator which reduces the voltage increase available for generating a spark. There is a need, in an outboard marine engine, for a spark ignition transformer which provides an extremely rapid rise in voltage so that misfires due to soot fouling are minimized.

### SUMMARY OF THE INVENTION

The present invention is directed to a direct fuel injection outboard marine engine having an improved spark ignition system. This spark ignition system comprises a magnetic core-coil assembly for generating a high-voltage signal within a short period of time and an electronic engine management module for energizing a primary coil of the magnetic core-coil assembly with a low-voltage signal at the appropriate time. The magnetic core is made of ferromagnetic amorphous metal alloy which exhibits low core loss and a permeability in the range of 100 to 500. Such magnetic properties are well suited for rapid firing of a spark plug during each piston stroke.

In accordance with one preferred embodiment, the magnetic core is in the shape of a torus. The high-voltage signal is output by a secondary coil wound around a major portion of the toroidal core, with the primary coil being wound around a minor portion of the toroidal core not covered by the secondary coil. The secondary coil outputs a high-voltage signal in response to excitation of the primary coil with a low-voltage signal generated by the ignition drive electronics.

The magnetic amorphous metal core-coil assembly in accordance with the preferred embodiment minimizes the number of engine misfires due to soot fouling. The resulting coil-per-plug spark ignition transformer generates a rapid voltage rise and a signal that accurately portrays the voltage profile of the ignition event. Energy transfer from the amorphous metal coil to the spark plug occurs in a very efficient manner, so that very little energy remains within the core after discharge. The low secondary resistance of the toroidal design allows the bulk of the energy to be dissipated in the spark and not in the secondary wire.

### BRIEF DESCRIPTION OF THE DRAWINGS

FIG. 1 is a schematic showing a side elevational view of one type of outboard marine propulsion device which may incorporate the present invention.

FIG. 2 is a schematic showing a partial sectional view of a direct fuel-injected internal combustion engine which may be incorporated in the outboard marine propulsion device shown in FIG. 1.

FIG. 3 is a schematic showing a partial sectional view of a direct fuel-injected internal combustion engine having a spark ignition system (indicated by blocks) in accordance with the preferred embodiment of the present invention.

FIG. 4 is a schematic showing a sectional view taken along line 4-4 in FIG. 3 and with the piston removed.

FIG. 5 is a schematic showing a top view of an exemplary magnetic core-coil assembly which can be incorporated in the spark ignition system depicted in FIG. 3.

### DETAILED DESCRIPTION OF THE PREFERRED EMBODIMENTS

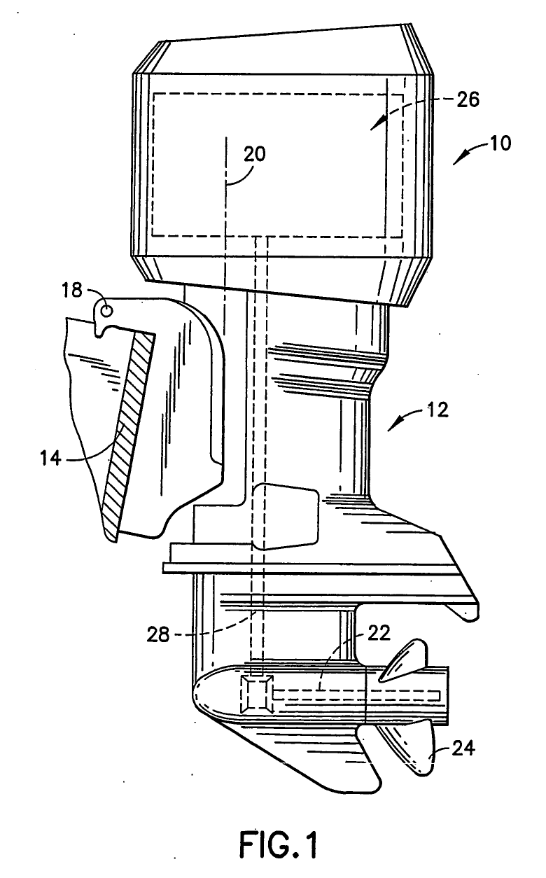

The present invention will be described in the context of an outboard marine propulsion device powered by a two-stroke direct fuel injection internal combustion engine for driving a propeller. However, it will be appreciated by those skilled in the art that the teachings of the present invention need not be limited to outboard systems or to two-stroke engine operation or to propeller systems since other applications, such as inboard engines, four-stroke engine operation and water jet propulsion units, may equally benefit from such teachings. An exemplary outboard marine propulsion device incorporating the invention is illustrated in FIG. 1.

The marine propulsion device 10 shown in FIG. 1 comprises an outboard drive unit 12 adapted to be mounted to a transom 14 of a boat for pivotal tilting movement relative thereto about a generally horizontal tilt axis 18 and for pivotal steering movement relative thereto about a generally vertical steering axis 20. Drive unit 12 comprises a propeller shaft 22 having a propeller 24 fixed thereto. In accordance with the preferred embodiments of the invention, the drive unit 12 comprises a direct fuel injection, two- or four-stroke internal combustion engine 26 (indicated by a dashed rectangle) drivingly connected to propeller shaft 22 by a conventional drive train 28.

Engine 26 may be a six-cylinder or a four-cylinder V-type engine. It should be understood, however, that the invention is applicable to other types of engines with any number of cylinders.

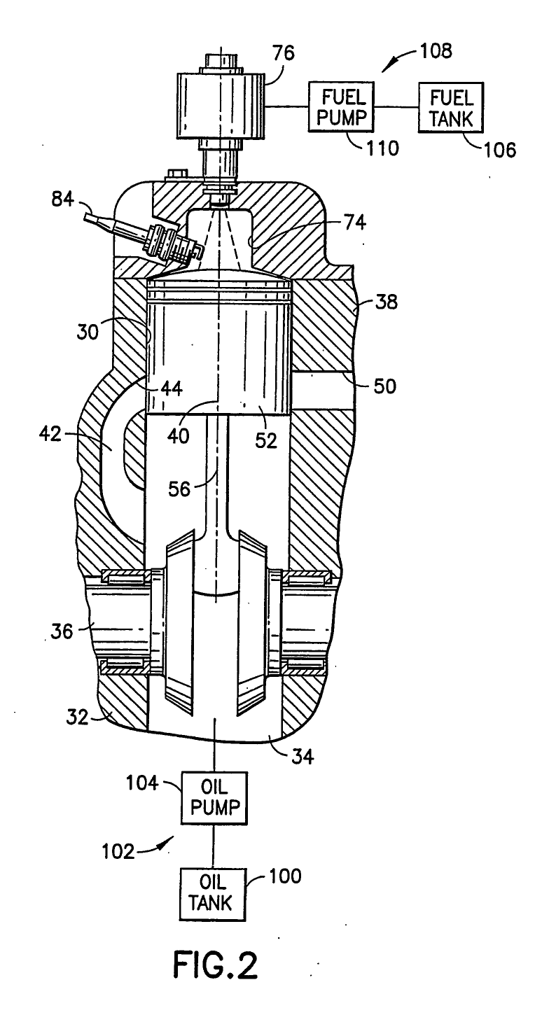

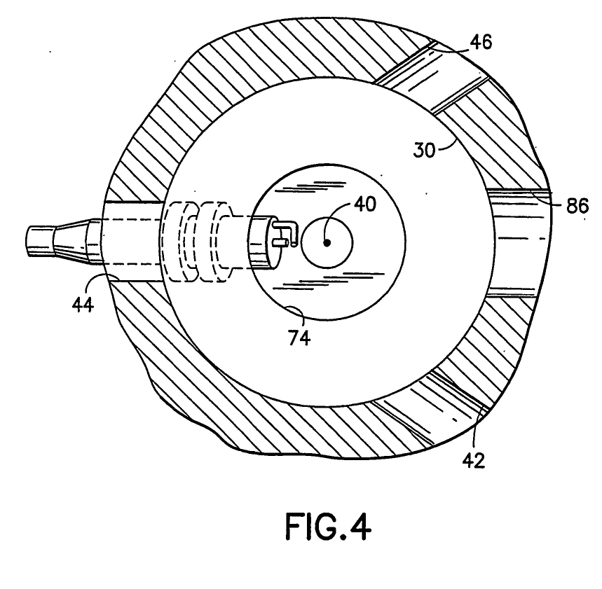

One exemplary cylinder 30 of engine 26 is illustrated in FIG. 2. Engine 26 comprises a crankcase 32 defining a crankcase chamber 34 and having a crankshaft 36 rotatable therein. An engine block 38 defines cylinder 30, which has a longitudinal axis 40 and an upper end (the upper end in FIG. 2). Engine block 38 may also define (see FIG. 4) a number of intake ports, e.g., three intake ports 42, 44 and 46 that communicate with cylinder 30. Each of the ports communicates with crankcase chamber 34 via a respective transfer passage 48 (one of which is shown in FIG. 2). Engine block 38 also defines an exhaust port 50 which communicates with cylinder 30 and which is located generally diametrically opposite the intake port 44. This construction is well known in the art and will not described in greater detail. Engine 26 also comprises a piston 52 which is reciprocally slidable in cylinder 30 along axis 40.

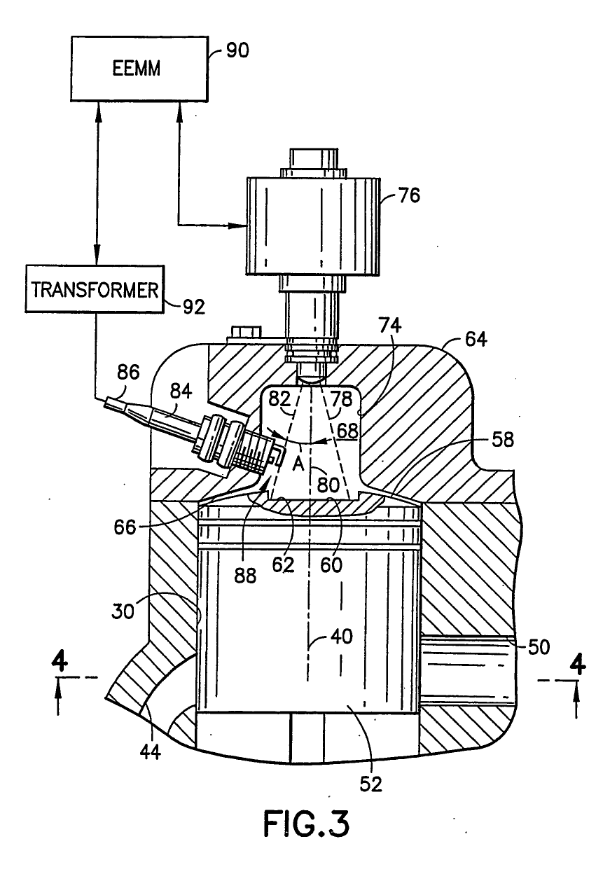

As will be readily understood by those skilled in the art of internal combustion engines, piston 52 is drivingly connected to a crankshaft 36 by a crank pin 56. By way of example and not of limitation, piston 52 could include (see FIG. 3) an upper surface 58 having therein a circular bowl 60. Bowl 60 has a planar bottom surface 62 perpendicular to the axis 40. The upper surface 58 surrounding the bowl 60 is convex, defining a portion of a sphere having a suitable radius of curvature. Engine 26 also comprises a cylinder head 64 including a lower surface portion 66 closing the upper end of cylinder 30 so as to define a combustion chamber 68 between piston upper surface 58 and cylinder head lower surface portion 66. When piston 52 is at top dead center, the piston upper surface 58 is suitably spaced from cylinder head lower surface portion 66. Cylinder head lower surface portion 66 extends generally perpendicular to the cylinder axis 40 and may include therein an upwardly extending recess or dome 74. In the illustrated exemplary embodiment, cylinder head lower surface portion 66 surrounding recess 74 is generally concave and complementary with piston upper surface 58. In the exemplary embodiment shown in FIG. 3, recess 74 is located directly above bowl 60 and is generally cylindrical, and centered on the cylinder axis 40. However, it will be appreciated by those skilled in the art that in general the recess need not be either cylindrical or centered on the cylinder axis. The recess 74 has an upper end and a lower end. In the exemplary construction, recess 74 has an area in a plane perpendicular to the cylinder axis 40 suitably dimensioned relative to the cross-sectional area of the cylinder.

Engine 26 further comprises a fuel injector 76 mounted on cylinder head 64 for injecting pressurized fuel into the upper end of recess 74. A fuel injector of this type is disclosed in U.S. Pat. No. 5,779,454. Fuel injector 76 conveniently creates a region, e.g., cone 78, of fuel spray surrounded by a volume of fuel vapor, cone 78 being centered on cylinder axis 40. Generally, most of the fuel spray cone 78 strikes the bottom surface 62 of the bowl 60 before striking any other surface. As shown in FIG. 3, fuel spray cone 78 may be centered on a cone axis 80 (coaxial with cylinder axis 40) and has an outside envelope defining a line 82 in a plane including the cone axis (the plane of the paper), line 82 and cone axis 80 forming a suitably dimensioned acute angle A.

Referring to FIG. 3, engine 26 also comprises a spark plug 84 which is mounted on cylinder head 64 and which extends into recess 74. Spark plug 84 may extend along a plug axis 86 which is located in the plane of cone axis 80 and line 82, and which is substantially perpendicular to line 82. Also, spark plug 84 could readily be located directly above intake port 44. Spark plug 84 includes a spark gap 88 that may be located outside fuel spray cone 78 and within the fuel vapor volume, so that spark plug 84 initially ignites fuel vapor rather than directly igniting the fuel spray.

An electronic engine management module 90 (see FIG. 3) coordinates the delivery of precise fuel quantities into the combustion chamber 68. Ignition of spark plug 84 is timed by the electronic engine management module 90 so that spark plug 84 ignites the fuel spray before the fuel spray strikes the piston upper surface 58. Two of the primary input signals used by the electronic engine management module 90 for controlling the engine's ignition timing, its fuel injectors and other components are input signals indicating the operator's speed request and the engine's speed. The electronic engine management module 90 is a conventional computer used by those of ordinary skill in the art of engine control, and comprises a central processing unit, random access memory, read only memory, analog-to-digital converters, input/output circuitry and clock circuitry. The electronic engine management module in accordance with the preferred embodiment is programmed to control fuel injection and spark ignition. In particular, the electronic engine management module 90 produces a low-voltage signal in a primary coil of a spark ignition transformer 92 when spark ignition is required. In response to this low-voltage activation signal, a secondary coil of the spark ignition transformer 92 outputs a high-voltage signal of extremely short duration to the spark plug 84. This process is repeated multiple times for each stroke of the piston.

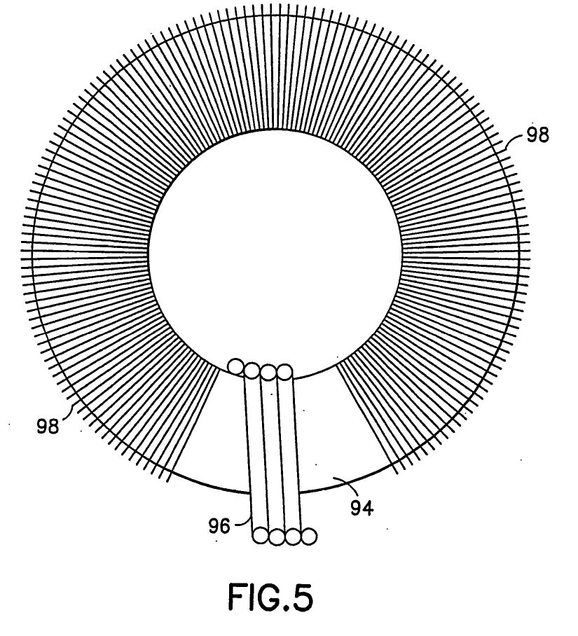

In accordance with the preferred embodiment, the spark ignition transformer 92 comprises a magnetic core-coil assembly of the type shown in FIG. 5. This magnetic core-coil assembly comprises a magnetic core 94 composed of a ferromagnetic amorphous metal alloy. The amorphous metal alloy may further comprise metallic elements such as nickel and cobalt, glass-forming elements such as boron and carbon, and semi-metallic elements such as silicon. The core-coil assembly further comprises a single primary coil 96 for low-voltage excitation and a secondary coil 98 for providing a high-voltage output in response to the low-voltage input to the primary coil. In accordance with one preferred embodiment, the magnetic core is in the shape of a torus. The primary coil is wound around a minor circumferential portion (e.g., 60 degrees) of the amorphous metal torus in sufficient proximity that the amorphous metal is coupled to the primary coil by electromagnetic induction when a low-voltage signal is input to the primary coil, e.g., by building up the current through the primary coil and then switching off the primary current, thereby producing a large change in magnetic flux in the amorphous metal torus. This current buildup and switching off process is controlled by the electronic engine management module. The secondary coil is wound around a major circumferential portion (e.g., 360 degrees) of the amorphous metal torus in sufficient proximity that the amorphous metal core is coupled to the secondary coil by electromagnetic induction when the amorphous metal undergoes the aforementioned large change in magnetic flux. The result is that a relatively low-voltage signal input to the primary coil is transformed into a relatively high-voltage signal output by the secondary coil, which high-voltage signal is used to ignite the spark plug.

Optionally, the core-coil assembly may comprise a plurality of stacked core subassemblies, each core subassembly comprising a respective toroidal magnetic core with a respective secondary coil wound around the core. In the latter case, the stacked core subassemblies are simultaneously energized via a single common primary coil.

A core-coil assembly constructed as shown in FIG. 5 has the capability of generating a high voltage in the secondary coil 98 within a short period of time. U.S. Pat. No. 5,868,123 discloses that such core-coil assemblies can repeatedly generate a high voltage, exceeding 10 kV, at time intervals of less than 100 μsec. In addition, such a core-coil assembly has the capability of sensing spark ignition conditions in the combustion chamber and providing that information to the electronic engine management module for optimally controlling the ignition event.

FIG. 5 shows a non-gapped structure. The core may have either a gapped or a non-gapped structure. An example of a gapped core is a toroidal-shaped magnetic core having a small slit commonly known as an air gap. The air-gap portion of the magnetic path reduces the overall permeability.

In accordance with the preferred embodiment of the invention, a non-gapped core can be constructed by winding an amorphous iron-based ribbon on a machined mandrel to form a core having generally circular cylindrical inner and outer surfaces. Preferably the wound core is annealed and then covered with insulating material, e.g., plastic. The annealed core is then wound with several (e.g., 2 to 10) turns of heavy-gauge insulated copper wire to form the primary coil. The secondary coil is formed by a multiplicity (e.g., more than 100) turns of thin-gauge insulated copper wire to form the secondary coil. The coil-core assembly is preferably potted in epoxy or polyurethane for high-voltage dielectric integrity. The basic requirements of the potting compound are that it possess sufficient dielectric strength, adhere well to all other materials inside the assembly, and be able to survive the stringent conditions imposed by cycling, high temperature, shock and vibration.

The terminals of the primary coil are electrically connected by one cable to respective terminals on the electronic engine management module, while the terminals of the secondary coil are electrically connected to the electrodes of the spark plug by another cable. In accordance with the preferred embodiment of the invention, the electronic engine management module and the magnetic core-coil assembly are both mounted on the engine. The primary coil is connected to the electronic engine management module and the secondary coil is connected with a separate cable to the spark plug.

Using techniques well understood in the art, engine 26 further comprises a source of primary lubricant, i.e. an oil tank 100 (shown schematically in FIG. 2), and a lubricant supply system 102 for supplying oil from oil tank 100 to the crankcase 32 of engine 26.

The lubricant supply system may include an oil pump 104 which pumps oil from the oil tank 100 to the crankcase chamber 34.

The engine also comprises a source of fuel, i.e., a fuel tank 106 (shown schematically in FIG. 2), and a fuel supply system 108 for accurately supplying pressurized (e.g., 250 psi) fuel to the various respective fuel injectors 76 of engine 26. The fuel supply system 108 includes a fuel pump 110 which pumps fuel from the fuel tank 106 to the fuel injectors 76.

The engine may also include a source of secondary lubricant which is mixed with the fuel injected into the cylinders 30. Although a separate lubricant source could be employed, in the illustrated exemplary construction, the source of fuel and the source of secondary lubricant are a single tank (fuel tank 106) of mixed fuel. The amount of secondary lubricant injected into the cylinders 30 by the fuel injectors 76 is substantially less than is necessary to adequately lubricate the engine 26. The purpose of the secondary lubricant is not lubrication of the engine 26, but rather is reduction of spark plug fouling. It has been found that mixing a relatively small amount of oil with the injected fuel significantly reduces spark plug fouling. In an alternative exemplary construction, the secondary lubricant is provided by a combined fuel and oil pump drawing fuel and oil from separate tanks. Any suitable fuel and oil pump can be employed. Another alternative would be using a completely separate oil pump drawing from a separate oil tank.

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. A direct fuel injection outboard marine engine comprising:
a cylinder comprising a cylinder head;
a piston slidable in said cylinder, said cylinder head and said piston forming a combustion chamber when said piston is in its uppermost position;
a spark plug comprising a pair of electrodes separated by a gap located inside said combustion chamber;
a fuel injector comprising a nozzle in communication with said combustion chamber; and
a spark ignition transformer comprising a core of ferromagnetic amorphous metal alloy, a primary coil coupled to said core by electromagnetic induction, and a secondary coil coupled to said core by electromagnetic induction and electrically coupled to said spark plug electrodes, wherein said secondary coil produces a relatively high-voltage signal across said spark plug electrodes in response to a low-voltage signal in said primary coil.

2. The engine as recited in claim 1, wherein said core is toroidal in shape.

3. The engine as recited in claim 1, wherein said primary coil is wound around a minor portion of said core and said secondary coil is wound around a major portion of said core.

4. The engine as recited in claim 1, wherein said amorphous metal alloy is iron-based.

5. The engine as recited in claim 4, wherein said amorphous metal alloy further comprises a metallic element other than iron.

6. The engine as recited in claim 4, wherein said amorphous metal alloy further comprises a glass-forming element.

7. The engine as recited in claim 4, wherein said amorphous metal alloy further comprises a semi-metallic element.

8. The engine as recited in claim 1, further comprising an electronic engine management module electrically coupled to produce said relatively low-voltage signal in said primary coil.

9. The engine as recited in claim 1, wherein said piston has two strokes per engine cycle.

10. The engine as recited in claim 1, wherein said piston has four strokes per engine cycle.

11. A direct fuel injection outboard marine engine comprising:
a cylinder comprising a cylinder head;
a piston slidable in said cylinder, said cylinder head and said piston forming a combustion chamber when said piston is in its uppermost position;
a spark plug comprising a pair of electrodes separated by a gap located inside said combustion chamber;
a fuel injector comprising a nozzle in communication with said combustion chamber;
a spark ignition transformer comprising a core of ferromagnetic amorphous metal alloy, a primary coil coupled to said core by electromagnetic induction, and a secondary coil coupled to said core by electromagnetic induction; and electrically coupled to said spark plug electrodes; and
an electronic engine management module programmed to control the timing and amounts of fuel injected into said combustion chamber by said fuel injector, and to control the timing and magnitude of a change in voltage level in said primary coil, wherein said secondary coil produces a relatively high-voltage signal across said spark plug electrodes in response to a change in voltage level produced in said primary coil by said electronic engine management module.

12. The engine as recited in claim 11, wherein said core is toroidal in shape.

13. The engine as recited in claim 11, wherein said primary coil is wound around a minor portion of said core and said secondary coil is wound around a major portion of said core.

14. The engine as recited in claim 11, wherein said amorphous metal alloy is iron-based.

15. The engine as recited in claim 11, wherein said piston has two strokes per engine cycle.

16. The engine as recited in claim 11, wherein said piston has four strokes per engine cycle.

17. A direct fuel injection outboard marine engine comprising:
a plurality of cylinders, each cylinder comprising a cylinder head;
a plurality of pistons, each piston being slidable in a respective one of said cylinders, said cylinder head of each cylinder and said corresponding piston forming a respective combustion chamber when said corresponding piston is in its uppermost position;
a plurality of spark plugs, each spark plug comprising a pair of electrodes separated by a gap located inside a respective one of said combustion chambers;
a plurality of fuel injectors, each fuel injector comprising a respective nozzle in communication with a respective one of said combustion chambers;
a plurality of spark ignition transformers, each spark ignition transformer comprising a core of ferromagnetic amorphous metal alloy, a primary coil coupled to said core by electromagnetic induction, and a secondary coil coupled to said core by electromagnetic induction and electrically coupled to the electrodes of a respective one of said spark plugs; and
a computer programmed to perform the following steps:
controlling the timing and amounts of fuel injected into each of said combustion chambers by the corresponding fuel injector; and
controlling the timing and magnitude of a change in voltage level in the primary coil of each of said spark ignition transformers, wherein the secondary coil of each spark ignition transformer produces a relatively high-voltage signal across the electrodes of the corresponding spark plug in response to said change in voltage level produced in the primary coil.

18. The engine as recited in claim 17, wherein said core is toroidal in shape, said primary coil is wound around a minor portion of said core and said secondary coil is wound around a major portion of said core.

19. The engine as recited in claim 17, wherein said amorphous metal alloy is iron-based.

20. The engine as recited in claim 17, wherein said piston has two strokes per engine cycle.
